(19) United States
(12) Patent Application Publication
(10) Pub. No.: US 2011/0205164 A1
(43) Pub. Date: Aug. 25, 2011

(54) METHOD OF CHANGING THE STATE OF AN ELECTRONIC DEVICE

(75) Inventors: Cody R. Hansen, Shelby Township, MI (US); Andrew W. Gellatly, Macomb, MI (US); Matthew M. Highstrom, South Lyon, MI (US)

(73) Assignee: GM GLOBAL TECHNOLOGY OPERATIONS, INC., Detroit, MI (US)

(21) Appl. No.: 12/711,052

(22) Filed: Feb. 23, 2010

(51) Int. Cl. G06F 3/041; G06F 3/01; G08B 21/00

(52) U.S. Cl. 345/173; 340/686.6; 340/669

(57) ABSTRACT

A method changes the state of an electronic device to a second state from a first state, where the electronic device includes an input portion for interaction with an object. The method includes the steps of: monitoring at least one sensor having a detection range at least partially disposed near the input portion, determining whether the object is within the detection range of the sensor, determining movement characteristics of the object when the object is detected, determining if the movement characteristics of the object put the object on a path to contact the input device, and changing the state of the electronic device from the first state to the second state when the object is on a path to contact the input device.

### FIELD

The present disclosure relates to an electronic device, and more particularly to an electronic device that changes state from a first state to a second state upon determining that an object will contact an input device of the electronic device.

### BACKGROUND

The statements in this section merely provide background information related to the present disclosure and may or may not constitute prior art.

Electronic devices such as navigation systems and entertainment systems are becoming more common in modern vehicles. These electronic devices typically include an area for user interaction with the device and an area for displaying information for the user. Some of these electronic devices include touch screen controls that integrate the interaction and display functions. These devices may include an off state or a low-brightness state of the display area that occurs when the user has not interacted with the electronic device for a certain amount of time. The devices are commonly put into an interaction or viewing state upon interaction between the user and the input area of the device. Waiting for the user to interact with the device, however, does not leave the user with the impression that the device is sophisticated. One solution is to change the state of the device from a standby state to an interaction state upon detection of an object in the proximity of the device. Proximity detection, however, may cause the device to enter the interaction state when the user is not going to interact with the device, such as when using a cup holder, shifting gears, or otherwise interacting with the instrument panel. Thus, there is a need for a new and improved electronic device that enters a ready state when the user intends to interact with the device.

### SUMMARY

In an aspect of the present invention, a method changes the state of an electronic device to a second state from a first state. The electronic device includes an input portion for interaction with an object. The method includes the steps of: monitoring at least one sensor having a detection range at least partially disposed near the input portion, determining whether the object is within the detection range of the sensor, determining movement characteristics of the object when the object is detected, determining if the movement characteristics of the object put the object on a path to contact the input device, and changing the state of the electronic device from the first state to the second state when the object is on a path to contact the input device.

In another aspect of the present invention, the electronic device is an infotainment system in a vehicle.

In yet another aspect of the present invention, the at least one sensor is a plurality of optical sensors.

In yet another aspect of the present invention, the at least one sensor is one of an at least one capacitive field sensor, an ultrasonic sensor, a radar sensor, and a thermal sensor.

In yet another aspect of the present invention, the movement characteristics include a path of the object.

In yet another aspect of the present invention, the movement characteristics include an acceleration of the object.

In yet another aspect of the present invention, changing the state of the electronic device from a first state to a second state includes adding content to a display in electronic communication with the electronic device.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic diagram of an electronic device in an exemplary instrument panel of a motor vehicle in accordance with an embodiment of the present invention;

FIG. 2 is an block diagram of an electronic device in accordance with an embodiment of the present invention; and

FIG. 3 is a flowchart illustrating a method of changing the state of an electronic device in accordance with an embodiment of the present invention.

### DETAILED DESCRIPTION

The following description is merely exemplary in nature and is not intended to limit the present disclosure, application, or uses.

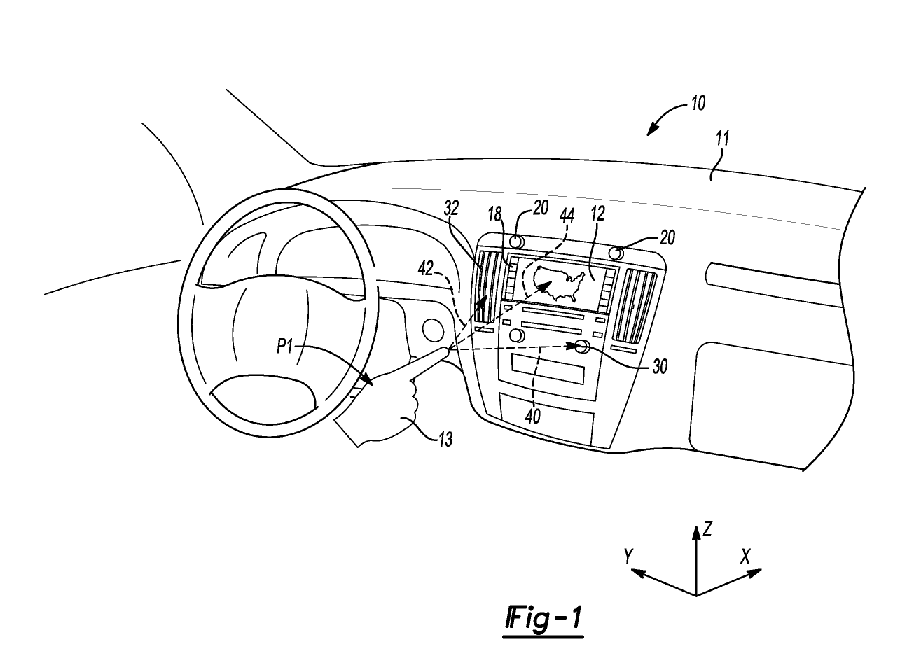

Referring to the drawings, wherein like reference numbers refer to like components, in FIG. 1 an operating environment 10 for an electronic device 12 is shown in accordance with an embodiment of the present invention. An object 13 is disposed in the operating environment 10 and may interact with the electronic device 12, as will be described below. In the example provided, the operating environment 10 is a cabin and an instrument panel 11 of a vehicle, the electronic device 12 is an infotainment system disposed in the instrument panel 11, and the object 13 is a hand of a user of the infotainment system. The infotainment system includes radio controls, a DVD player, and a navigation system. The radio controls provide access to AM, FM, and satellite radio frequencies. It should be appreciated that the infotainment may also include heating and air conditioning controls, telemetric controls, vehicle status information, and other information or controls that a user of a vehicle may desire.

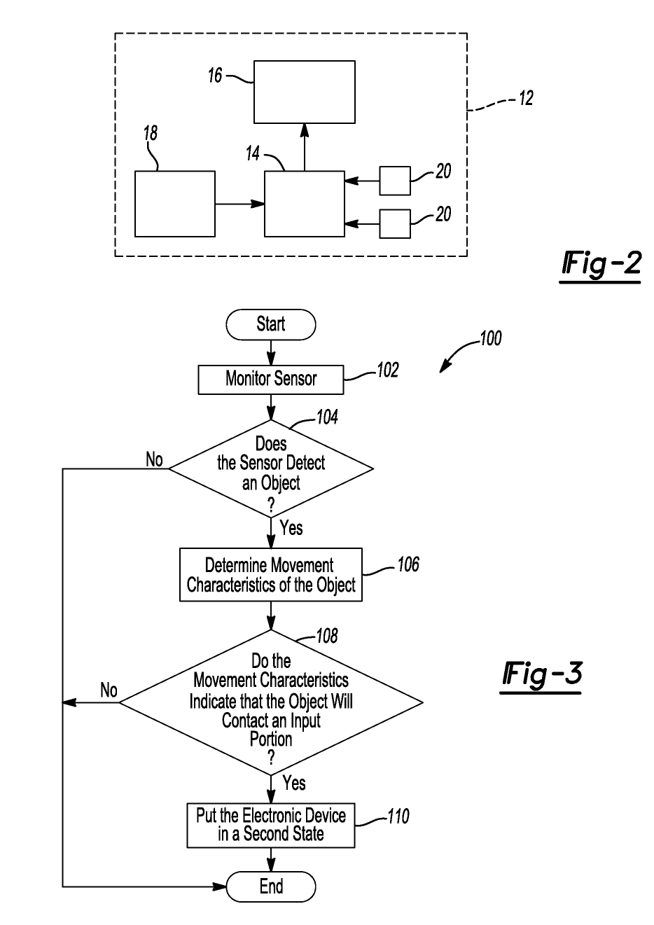

Referring now to FIG. 2 and with continued reference to FIG. 1, the electronic device 12 includes a controller 14, a display 16, an input portion 18, and at least one sensor 20. The controller 14 has control logic for determining an acceleration and an estimated path of the object 13, as will be operationally described below. In the example provided, the estimated path is at least partially determined by the acceleration of the object 13. The controller 14 typically includes at least a digital processor and memory for executing a variety of software or firmware applications, including the control logic. The electronic device 12 may be in various states, including a standby or first state and a proximity or second state. The electronic device 12 is generally in the first state when the user is not interacting and is not expected to interact with the electronic device 12. For example, the first state may be designed not to distract the user of the vehicle or may be designed for power conservation. The electronic device 12 is in the second state when the user is interacting or is about to interact with the electronic device 12. For example, in the second state the electronic device 12 may present options and controls that were not displayed in the first state or may activate the display 16.

The display 16 is in electronic communication with the controller 14 to visually present information from the software or firmware to the user of the electronic device 12. The display 16 may be any suitable type, such as a liquid-crystal display or an organic light emitting diode display. The display 16 may be disposed in any suitable location on the instrument panel 11 that allows the user to read information presented on the display 16. In the example provided, the display 16 is in a low brightness or an off condition in the first state and is in a viewing condition in the second state.

The input portion 18 is in electronic communication with the controller 14 to provide the user with a way to interact with the electronic device 12. The input portion 18 may contain a variety of buttons, switches, or pressure sensitive areas for accepting input from the user. The input portion 18 may be disposed in any suitable location in reach of the user, such as the center of the instrument panel 11. In the example provided, the display 16 and the input portion 18 are integrated into a touch screen. In embodiments where the electronic device 12 is designed not to distract the user, the first state may be a de-contented condition where some images and information are not presented on the display 16 and the second state may be a full-contented state where the display 16 presents all images, buttons, and information.

The at least one sensor 20 is in electronic communication with the controller 14 to provide data relating to objects near the input portion 18. The sensor 20 is capable of providing sufficient data to determine an acceleration of objects near the input portion 18. In the example provided, the sensor 20 is a pair of optical sensors disposed on the dashboard. The optical sensors are preferably separated from each other on the dashboard to allow the sensors 20 or the controller 14 to determine a distance to the object 13 by analyzing differences in the images produced by the optical sensors. The sensor 20, however, may be another type of sensor, such as a capacitive field sensor, an ultrasonic sensor, a radar sensor, or a thermal sensor without departing from the scope of the present invention. A capacitive field sensor detects changes in an electromagnetic field due to the presence and movement of the object 13, whereas ultrasonic, radar, and thermal sensors detect presence and movement of the object 13 by analyzing sound waves, electromagnetic waves, and radiation heat transfer, respectively.

The operating environment 10 includes other devices that the object 13 may interact with instead of interacting with the electronic device 12. In the example provided, a temperature control knob 30 and an adjustable air vent 32 are provided as examples of the other devices.

With continued reference to FIG. 1, the operation of the electronic device 12 and the control logic within the operating environment 10 will now be described. The operating environment 10 is illustrated with a coordinate system having a first direction X, a second direction Y, and a third direction Z. It should be appreciated that the directions X, Y, Z are oriented for explanation only, and may be oriented at other angles without departing from the scope of the present invention.

The object 13 may move from an initial position P1 along any path through the operating environment, such as path 40, path 42, or path 44, among others. Path 40 is an example of the object 13 moving from the initial position P1 towards the temperature control knob 30. In the example provided, the path 40 ends at approximately the same point along the first direction X as the input portion 18, but ends below the input portion 18 along the third direction Z. Path 42 is an example of the object 13 moving from the initial position P1 to the adjustable air vent 32. Path 42 ends at approximately the same point along the first direction X and the third direction Z as the input portion 18, but ends at a point along the second direction Y that is different from the location of the input portion 18. The path 44 is an example of the object 13 moving from the initial position P1 to the input portion 18 of the electronic device 12. Accordingly, the path 44 ends at the same points along each of the directions X, Y, Z.

The control logic of the electronic device 12 monitors the sensors 20, determines an acceleration and an estimated path of the object 13, determines whether the object 13 will contact the input portion 18, and changes the state of the device from a first state to a second state. In the example provided, when the object 13 is on the path 40, the control logic will determine that the object 13 will not contact the input portion 18 due to the expected position of the object 13 below the input portion 18 along the third direction Z when the object 13 is aligned with the input portion 18 in the second direction Y. Therefore, when the object 13 is on the path 40, the controller 14 will not change the state of the electronic device 12. When the object 13 is on the path 42, the control logic will determine that the object 13 is not on a path to contact the input portion 18 due to the expected position of the object 13 along the second direction Y when the object 13 is aligned with the input portion 18 in the first direction X. Therefore, the controller 14 will not change the state of the electronic device when the object 13 is on the path 42. When the object 13 is on the path 44, the control logic will determine that the acceleration and the path of the object 13 indicate that the object 13 is on an expected path that crosses a location of the input portion 18 along each of the directions X, Y, Z. Therefore, when the object 13 is on the path 44, the controller 14 will change the state of the electronic device 12 from the first state to the second state prior to the object 13 reaching the control device 12. It should be appreciated that the control logic may determine the acceleration and the expected path using other methods without departing from the scope of the present invention.

Referring now to FIG. 3, a method of changing the state of the electronic device 12 from a first state to a second state is shown and generally indicated by reference number 100. In step 102 the controller 14 monitors data from the sensors 20. This data is indicative of a coordinal location of any object 13 sensed by the sensors 20, as well as the vector and acceleration of any object sensed by the sensors. In step 104, the data from the sensors 20 are analyzed to determine whether the object 13 is detected. If no object 13 is detected, the method is complete and the electronic device 12 stays in the first state. If the object 13 is detected, the method proceeds to step 106 where the movement characteristics of the object 13 are determined. As noted above, the movement characteristics include an acceleration and an estimated path of the object 13. In step 108 the control logic of the controller 14 determines whether the movement characteristics of the object 13 indicate that the object 13 will contact the input portion 18 of the electronic device 12. The controller 14 uses software algorithms to determine the estimated destination of the object 13. If the movement characteristics indicate that the object 13 will not contact the input portion 18, then the method ends and the electronic device 12 remains in the first state. If the movement characteristics indicate that the object 13 will contact the input portion 18, then the method proceeds to step 110 where the control logic of the controller 14 changes the state of the electronic device 12 from the first state to the second state. The method 100 may be repeated as necessary to monitor the sensors 20 for the object 13.

The present invention has many benefits over the prior art. One such advantage is presenting the user with a sense that the electronic device 12 is sophisticated. Furthermore, the present invention provides the sense of sophistication while reducing erroneous changes to the second state.

The description of the invention is merely exemplary in nature and variations that do not depart from the gist of the invention are intended to be within the scope of the invention. Such variations are not to be regarded as a departure from the spirit and scope of the invention.

What is claimed is:

1. A method of changing the state of an electronic device to a second state from a first state, the electronic device including an input portion, the method comprising the steps of:
monitoring at least one sensor having a detection range at least partially disposed near the input portion;
determining whether an object is within the detection range of the sensor;
determining movement characteristics of the object when the object is detected;
determining if the movement characteristics of the object put the object on a path to contact the input device; and
changing the state of the electronic device from the first state to the second state when the object is on a path to contact the input device before the object contacts the electronic device.

2. The method of claim 1, wherein the electronic device is an infotainment system in a vehicle.

3. The method claim 1, wherein the at least one sensor is a plurality of optical sensors.

4. The method of claim 1, wherein the at least one sensor is one of an at least one capacitive field sensor, an ultrasonic sensor, a radar sensor, and a thermal sensor.

5. The method of claim 1, wherein the movement characteristics include a path of the object.

7. The method of claim 1, wherein the movement characteristics include an acceleration of the object.

8. The method of claim 1, wherein changing the state of the electronic device from a first state to a second state includes adding content to a display in electronic communication with the electronic device.

9. A method of determining when an object is going to interact with an infotainment system in a vehicle, the method comprising the steps of:
providing the infotainment system in a standby state, the infotainment system having a display and an input portion;
providing at least one sensor capable of determining an acceleration of the object when it is in proximity to the infotainment system;
monitoring the at least one sensor for the object;
analyzing data from the at least one sensor to determine an acceleration and an estimated path of the object;
determining whether the acceleration and the estimated path of the object indicate that the object will contact the input portion of the infotainment system; and
putting the infotainment system in a ready state when it is determined that the user will contact the input portion of the infotainment system before the object contacts the input portion.

10. The method of claim 9, wherein the at least one sensor is a capacitive field sensor.

11. The method of claim 9, wherein the at least one sensor is a pair of optical sensors.

12. An electronic device that is capable of a first state and a second state, the electronic device comprising:
an input portion;
a display portion;
at least one sensor having a detection range at least partially disposed near the input portion for detecting an object;
a first control logic that determines movement characteristics of the object;
a second control logic that determines whether the movement characteristics put the object on a path to contact the input portion; and
a third control logic to put the electronic device in the second state if the object is on a path to contact the input portion before the object contacts the input portion.

13. The electronic device of claim 12, wherein the input portion and the display portion are combined into a touch screen.

14. The electronic device of claim 12, wherein the electronic device is an infotainment system in a vehicle.

15. The electronic device of claim 12, wherein the at least one sensor is one of an ultrasonic sensor, a plurality of optical sensors, a radar sensor, and a thermal sensor.

16. The electronic device of claim 12, wherein the at least one sensor is at least one capacitive field sensor.

17. The electronic device of claim 12, wherein the movement characteristics include an estimated path of the object.

18. The electronic device of claim 12, wherein the movement characteristics include an acceleration of the object.

19. The electronic device of claim 12, wherein the first state has the display in one of a low-brightness condition, a de-contented condition, and an off condition, and wherein the second state has the display in one of a viewing condition and a full-contented condition.

20. The electronic device of claim 12, wherein the first state has the display in a de-contented condition and the second state has the display in a full-contented condition.
